(19) United States
(12) Patent Application Publication
(10) Pub. No.: US 2024/0416976 A1
(43) Pub. Date: Dec. 19, 2024

(54) POSITION ESTIMATION DEVICE, MOVING OBJECT SYSTEM, POSITION ESTIMATION METHOD, AND NON-TRANSITORY COMPUTER READABLE MEDIUM

(71) Applicant: NEC Corporation, Minato-ku, Tokyo (JP)

(72) Inventor: Akira TSUJI, Tokyo (JP)

(73) Assignee: NEC Corporation, Minato-ku, Tokyo (JP)

(21) Appl. No.: 18/695,050

(22) PCT Filed: Oct. 5, 2021
(86) PCT No.: PCT/JP2021/036868

§ 371 Date: Mar. 25, 2024

(51) Int. Cl. B61L 25/02; G01C 21/02

(52) U.S. Cl. CPC B61L 25/025; G01C 21/02

(57) ABSTRACT

Provided is a position estimation device capable of appropriately grasping a position of a moving object. According to the present disclosure, a position estimation device (10) includes an acquisition unit (11) configured to acquire shape information of a surface of a structure around a moving object, an extraction unit (12) configured to extract a feature portion indicating a shape change of the surface of the structure from the shape information and extract feature information including a position and a size of the feature portion, a storage unit (13) configured to store, in advance, reference information including a position and a size of a reference portion that is a reference for position estimation, and an estimation unit (14) configured to compare the feature information with the reference information and estimates a current position of the moving object.

### TECHNICAL FIELD

The present disclosure relates to a position estimation device, a moving object system, a position estimation method, and a non-transitory computer readable medium.

### BACKGROUND ART

In recent years, a navigation system of a vehicle using a signal transmitted from global positioning system (GPS) satellites has been used. By using such a system, a user can grasp position information of the traveling vehicle in real time. On the other hand, in a tunnel or the like, it is not possible for a vehicle-side device to receive a signal from the GPS satellites. Therefore, it is not possible for the user to appropriately grasp the position of the vehicle. In such a case, it is also conceivable to use a current position estimation technique based on sensor data such as simultaneous localization and mapping (SLAM). However, unlike in an urban area or the like, there is little change in the surrounding environment in a tunnel or the like, and hardly any change in sensor data occurs. Therefore, even if SLAM is used, it is difficult to specify the position of the vehicle in a tunnel or the like.

As a related technique, Patent Literature 1 discloses a train position detection device capable of detecting a position of a train in a tunnel or the like. This device includes a train device and a central management device. The train device includes light irradiation means for enabling irradiation a predetermined area in a plane on the front side of the train with light at different irradiation angles with respect to a train traveling direction, and light receiving means for enabling reception of light reflected by an object. In addition, the train device determines the outer peripheral shape of the object in front of the train based on the light irradiation angle and the time from the irradiation with the light to the reception of the reflected light. Then, the train device detects the position of the train based on the determined outer peripheral shape of the object, and an object information database and a position information database, which are stored in advance.

### CITATION LIST

### Patent Literature

Patent Literature 1: Japanese Unexamined Patent Application Publication No. 2021-024521

### SUMMARY OF INVENTION

### Technical Problem

In a case using the technique disclosed in Patent Literature 1, an object as a light irradiation target is required in front of the train. Therefore, in a case where such an object is not installed in a tunnel, it is necessary to install a new facility that is an irradiation target, for train position detection, and the cost increases. In addition, for example, in a water conduit or the like, it is not possible to easily install such a facility in some cases.

In view of such a problem, an object of the present disclosure is to provide a position estimation device, a moving object system, a position estimation method, and a non-transitory computer readable medium capable of appropriately grasping a position of a moving object.

### Solution to Problem

According to the present disclosure, there is provided a position estimation device configured to estimate a current position of a moving object.

The position estimation device includes
acquisition means for acquiring shape information of a surface of a structure around a moving object,
extraction means for extracting a feature portion indicating a shape change of the surface of the structure from the shape information and extracting feature information including a position and a size of the feature portion,
storage means for storing, in advance, reference information including a position and a size of a reference portion that is a reference for position estimation, and
estimation means for comparing the feature information with the reference information and estimating the current position of the moving object.

According to the present disclosure, there is provided a moving object system including
a moving object, and
a position estimation device mounted on the moving object.

The position estimation device includes
acquisition means for acquiring shape information of a surface of a structure around the moving object,
extraction means for extracting a feature portion indicating a shape change of the surface of the structure from the shape information and extracting feature information including a position and a size of the feature portion,
storage means for storing, in advance, reference information including a position and a size of a reference portion that is a reference for position estimation, and
estimation means for comparing the feature information with the reference information and estimating the current position of the moving object.

According to the present disclosure, there is provided a position estimation method of estimating a current position of a moving object.

The position estimation method includes
acquiring shape information of a surface of a structure around a moving object,
extracting a feature portion indicating a shape change of the surface of the structure from the shape information and extracting feature information including a position and a size of the feature portion, and
comparing the feature information with reference information including a position and a size of a reference portion that is a reference for position estimation, and estimating the current position of the moving object.

According to the present disclosure, there is provided a non-transitory computer readable medium storing a program for causing a computer to execute a position estimation method of estimating a current position of a moving object.

The program causes the computer to execute
an acquisition process of acquiring shape information of a surface of a structure around the moving object,
an extraction process of extracting a feature portion indicating a shape change of the surface of the structure from the shape information and extracting feature information including a position and a size of the feature portion, and
an estimation process of comparing the feature information with reference information including a position and a size of a reference portion that is a reference for position estimation, and estimating the current position of the moving object.

### Advantageous Effects of Invention

According to the present disclosure, it is possible to provide a position estimation device, a moving object system, a position estimation method, and a non-transitory computer readable medium capable of appropriately grasping a position of a moving object.

### BRIEF DESCRIPTION OF DRAWINGS

FIG. 1 is a block diagram illustrating a configuration of a position estimation device according to a first example embodiment.

FIG. 2 is a flowchart illustrating position estimation processing according to the first example embodiment.

FIG. 3 is an outline diagram of a moving object system according to a second example embodiment.

FIG. 4 is a block diagram illustrating a configuration of the moving object system according to the second example embodiment.

FIG. 5 is a diagram illustrating an example of a reference portion according to the second example embodiment.

FIG. 6 is a diagram illustrating an example of reference information corresponding to the reference portion illustrated in FIG. 5.

FIG. 7 is a diagram illustrating an outline of sensing performed by a sensor and an example of a feature portion, according to the second example embodiment.

FIG. 8 is a diagram illustrating an example of feature information corresponding to the feature portion illustrated in FIG. 7.

FIG. 9 is a flowchart illustrating position estimation processing according to the second example embodiment.

FIG. 10 is a block diagram illustrating a configuration of a moving object system according to a third example embodiment.

FIG. 11 is a diagram illustrating an outline of sensing performed by a first sensor and a second sensor according to the third example embodiment.

FIG. 12 is a diagram illustrating an example of reference information according to a fourth example embodiment.

FIG. 13 is a diagram illustrating one of an outline of sensing of a sensor, a reference portion, and a feature portion according to the fourth example embodiment.

FIG. 14 is a flowchart illustrating position estimation processing according to the fourth example embodiment.

FIG. 15 is a block diagram illustrating a configuration example of hardware.

### EXAMPLE EMBODIMENT

Hereinafter, example embodiments of the present disclosure will be described in detail with reference to the drawings. In the drawings, the same or corresponding elements are denoted by the same reference signs. For clarity of description, repetitive description will be omitted as necessary.

### First Example Embodiment

An example embodiment of the present disclosure will be described below with reference to the drawings.

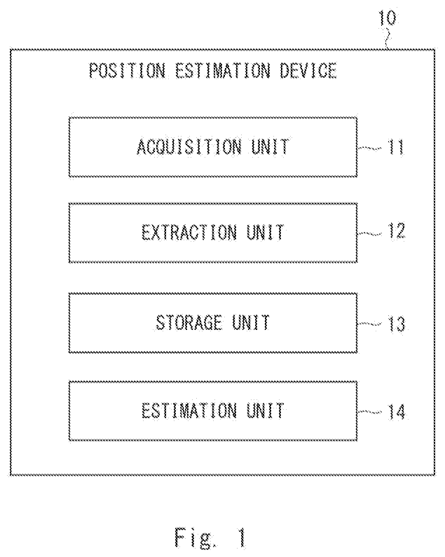

FIG. 1 is a block diagram illustrating a configuration of a position estimation device 10 according to the present example embodiment. The position estimation device 10 is an information processing device that estimates the current position of a moving object. The position estimation device 10 includes an acquisition unit 11, an extraction unit 12, a storage unit 13, and an estimation unit 14.

The acquisition unit 11 acquires shape information of the surface of a structure around the moving object.

The extraction unit 12 extracts a feature portion indicating a shape change of the surface of the structure from the shape information, and extracts feature information including the position and the size of the feature portion.

The storage unit 13 stores, in advance, reference information including the position and the size of a reference portion that is a reference for position estimation.

The estimation unit 14 compares the feature information with the reference information and estimates the current position of the moving object.

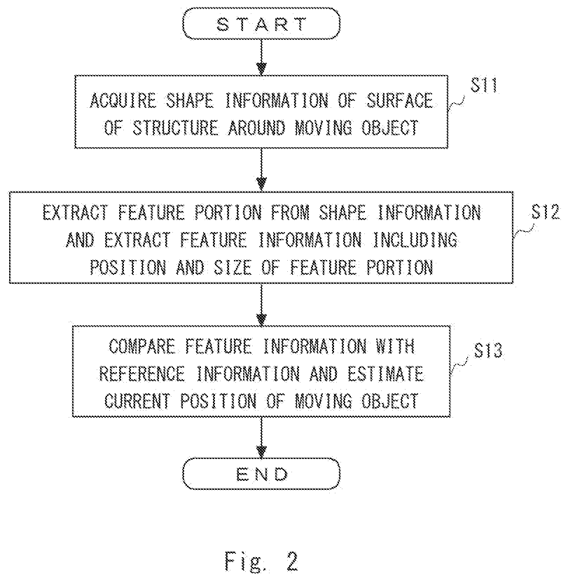

FIG. 2 is a flowchart illustrating position estimation processing performed by the position estimation device 10 according to the present example embodiment. Note that, it is assumed that the storage unit 13 stores, in advance, the reference information including the position and the size of the reference portion.

First, the acquisition unit 11 acquires shape information of the surface of a structure around a moving object (S11). Then, the extraction unit 12 extracts a feature portion from the shape information, and extracts feature information including the position and the size of the feature portion (S12). Then, the estimation unit 14 compares the feature information with the reference information and estimates the current position of the moving object (S13).

As described above, the position estimation device 10 according to the present example embodiment estimates the current position of the moving object based on the reference information stored in advance and the feature information extracted from the surface of the structure around the moving object. The feature information includes information indicating a shape change of the surface of the structure. With such a configuration, according to the position estimation device 10 according to the present example embodiment, it is possible to appropriately grasp the position of the moving object.

### Second Example Embodiment

Next, a configuration example of a moving object system 1000 according to a second example embodiment will be described. The present example embodiment is a specific example of the first example embodiment described above.

The moving object system 1000 includes a moving object and a position estimation device 100 mounted on the moving object. The moving object system 1000 estimates the current position of the moving object by the position estimation device 100 performing position estimation processing.

In the present example embodiment, the position of the moving object can be estimated even in an environment where it is not possible to receive a signal from a GPS satellite. Thus, the present example embodiment is also applicable to a case where a moving object moves inside a structure having a hollow shape, such as a tunnel or a water conduit.

The moving object includes moving means for moving in a space. The moving means may include, for example, a driving mechanism for moving on the ground, in the air, on a water surface, under water, or the like. The moving object is, for example, an automobile, a train, a drone, or the like. Further, the moving object may be a person. For example, the moving object system 1000 may be realized by a person carrying the position estimation device 100. In addition, the position estimation device 100 may be placed on a cart or the like, and a person may push and walk the cart, for example.

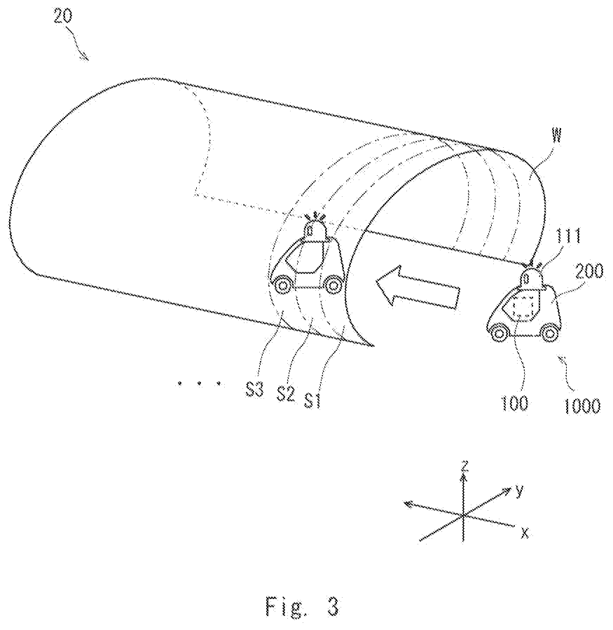

An outline of the moving object system 1000 will be described with reference to FIG. 3.

FIG. 3 is an outline diagram of the moving object system 1000 according to the present example embodiment. As illustrated in FIG. 3, in the present example embodiment, the description will be made on the assumption that the structure is a tunnel 20 for a vehicle and the moving object is a vehicle 200 traveling in the tunnel 20.

The vehicle 200 is equipped with the position estimation device 100. In addition, the vehicle 200 includes a sensor 111 capable of sensing the inside of the tunnel 20. The sensor 111 scans an inner wall W of the tunnel 20 and acquires shape information of the surface of the inner wall W. The shape information will be described later.

In the present example embodiment, the positional relationship of the components may be described using the coordinate system illustrated in FIG. 3. Here, it is assumed that an axial direction of the tunnel 20 is an x-axis, a width direction is a y-axis, and a vertical direction is a z-axis. The following drawings respectively have a common axial direction. The vehicle 200 enters the tunnel 20 from the right side of the paper surface in FIG. 3 and travels in the x-axis direction as indicated by an outlined arrow. The vehicle 200 travels in the tunnel 20 while scanning the inner wall W of the tunnel 20 with the sensor 111.

The position estimation device 100 scans the inner wall W in the order of sections S1, S2, S3, . . . illustrated in FIG. 3, for example. The sections S1, S2, S3, . . . are areas obtained by division in a traveling direction (positive direction of the x-axis) of the vehicle 200 at predetermined distance intervals, and are appropriately illustrated for easy description. The position estimation device 100 acquires a scanning result of each section, and performs position estimation processing to be described later by using the scanning results. As a result, the position estimation device 100 estimates the current position of the vehicle 200.

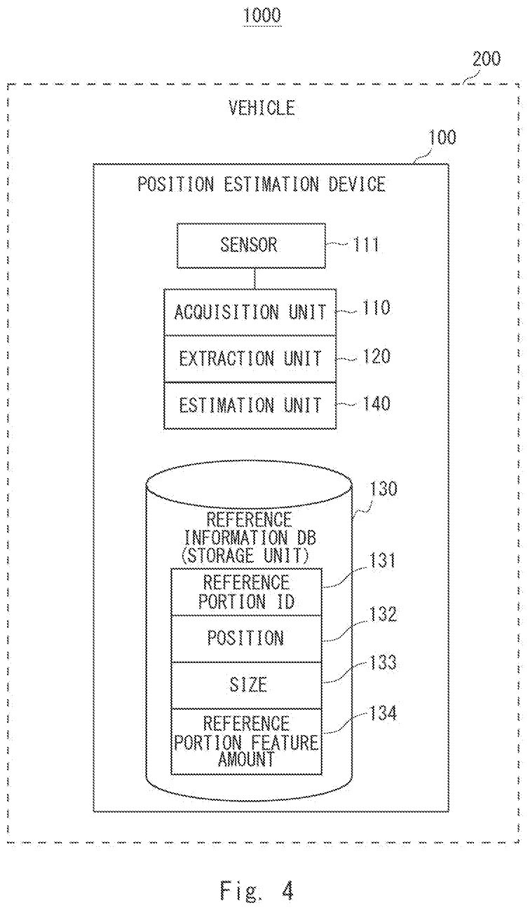

Next, a configuration of the moving object system 1000 will be described. FIG. 4 is a block diagram illustrating the configuration of the moving object system 1000 according to the present example embodiment. The moving object system 1000 includes the vehicle 200 and the position estimation device 100 mounted on the vehicle 200.

Note that the configuration illustrated in FIG. 4 is merely an example, and the moving object system 1000 may be configured using a device or the like in which a plurality of configurations are integrated. For example, each functional unit in the position estimation device 100 may be subjected to distributed processing using a plurality of devices or the like. In addition, although the sensor 111 is illustrated inside the position estimation device 100 in FIG. 4, the installation place of the sensor 111 is not limited. For example, the sensor 111 may be installed on an outer surface of the vehicle 200.

The vehicle 200 is an example of the moving object that moves in the tunnel 20. The vehicle 200 may be an automated driving vehicle. In addition, as described above, the vehicle 200 may be another moving object such as a drone. The vehicle 200 proceeds in the positive direction of the x-axis in the tunnel 20 while scanning the inner wall W with the sensor 111.

The position estimation device 100 corresponds to the position estimation device 10 in the first example embodiment. The position estimation device 100 is an information processing device that estimates the current position of the vehicle 200.

As illustrated in FIG. 4, the position estimation device 100 includes the sensor 111, an acquisition unit 110, an extraction unit 120, a reference information database (DB) 130, and an estimation unit 140.

First, the reference information DB 130 will be described.

The reference information DB 130 corresponds to the storage unit 13 in the first example embodiment. The reference information DB 130 functions as a storage unit that stores reference information of a reference portion that is a reference for position estimation. Here, the reference portion is a portion where a shape change on the surface of the inner wall W is detected. The shape change may be detected by the extraction unit 120 using a known image recognition technique or the like, or may be detected by visual inspection by a person.

The shape change may include a change over time in the surface of the inner wall W. The shape change indicates, for example, deterioration of the surface of the inner wall W. The shape change is, for example, pockmarks (surface bubbles), peeling, flaking, cracking, or the like occurring on the surface of the inner wall W. The shape change is not limited thereto, and may include a recessed portion, a protruding portion, or other changes indicating the deterioration of the surface of the inner wall W.

The reference information is information indicating a feature of the reference portion. For example, the reference information is obtained by associating a reference portion ID 131, a position 132 of the reference portion, a size 133, and a reference portion feature amount 134.

The reference portion ID 131 is information for identifying the reference portion.

The position 132 is information indicating the position of the reference portion. The position 132 may be indicated by, for example, xyz coordinates with the entrance of the tunnel 20 as an origin.

The size 133 is information indicating the size of the shape change at the reference portion. The size 133 may include, for example, a vertical length, a transverse length, and a depth of the shape change at the reference portion. Note that, in the following description, the size of the shape change at the reference portion may be simply referred to as the “size of the reference portion”. In addition, similarly, the size of the shape change at the feature portion to be described later may be simply referred to as the “size of the feature portion”.

The reference portion feature amount 134 is information indicating a feature amount of the shape change at the reference portion. For example, the reference portion feature amount 134 may indicate a shape, a size, a degree thereof, and the like of pockmarks, peeling, or the like. The reference portion feature amount 134 is calculated based on, for example, the size 133 of the shape change. The reference portion feature amount 134 may be calculated in consideration of the position 132. The reference portion feature amount 134 can be acquired by using, for example, a known technique such as artificial intelligence (AI). For example, the reference portion feature amount 134 is acquired by learning (for example, deep learning or the like) a large number of images and generating a model for detecting the feature amount of the shape change. The reference portion feature amount 134 may be extracted by the extraction unit 120, or may be stored in the reference information DB 130 in advance by another means.

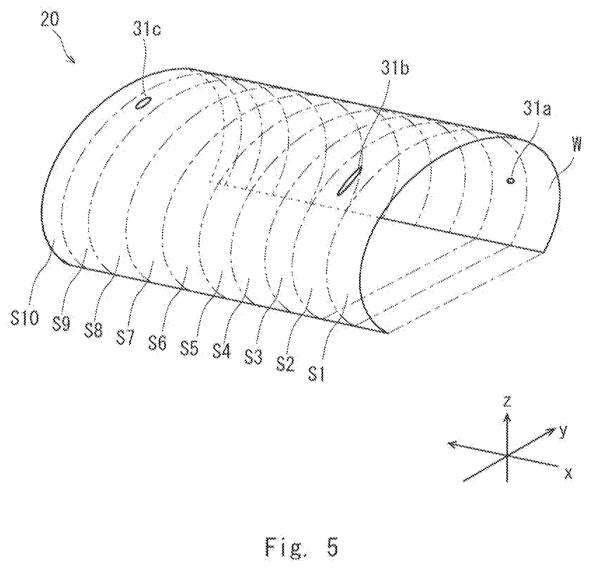

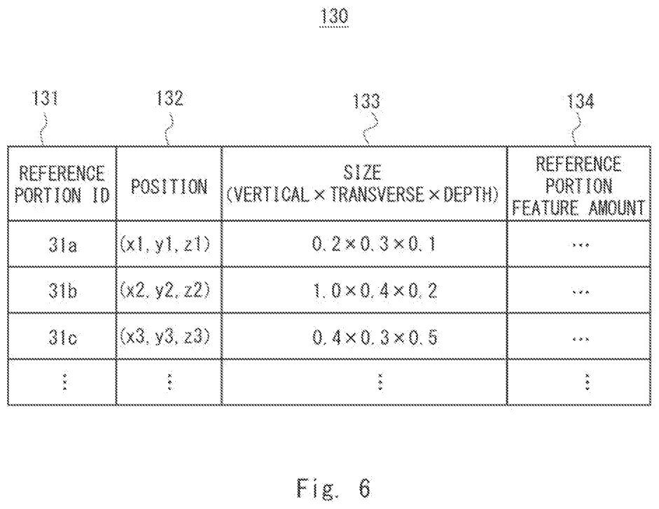

A specific example of the reference information will be described with reference to FIGS. 5 and 6. FIG. 5 is a diagram illustrating an example of the reference portion. In addition, FIG. 6 is a diagram illustrating an example of the reference information corresponding to the reference portion illustrated in FIG. 5. As illustrated in FIG. 5, reference portions 31a to 31c are detected on the surface of the inner wall W. The reference portions 31a to 31c are detected by, for example, past inspections in the tunnel 20. The past inspection may be performed by using the position estimation device 100 or may be performed by another method. For example, a result of visual inspection by a person or a result of inspection using another device may be used.

FIG. 6 illustrates reference information corresponding to the reference portions 31a to 31c. As illustrated in FIG. 6, the reference information DB 130 stores a reference portion ID 131, a position 132 of each reference portion, a size 133, and a reference portion feature amount 134 in association with each other. The reference information DB 130 may update the reference information in a case where the inspection of the tunnel 20 is performed again. In addition, the reference information DB 130 may delete the reference information of the reference portion, for example, in a case where the reference portion is repaired.

Returning to FIG. 4, the description will be continued.

The acquisition unit 110 corresponds to the acquisition unit 11 in the first example embodiment. The acquisition unit 110 includes the sensor 111. The acquisition unit 110 acquires shape information of the surface of the inner wall W around the vehicle 200 by using the sensor 111. The shape information is information regarding the shape of the surface of the inner wall W. The shape information may be, for example, three-dimensional point cloud data that is a set of three-dimensional coordinates of the surface of the inner wall W, and the like. Note that the periphery of the vehicle 200 is a space that can be sensed by using the sensor 111.

The sensor 111 senses the periphery of the vehicle 200. The shape of an object in a space around the vehicle 200 is detected, and shape information of the object is acquired. The sensor 111 outputs the shape information to the acquisition unit 110.

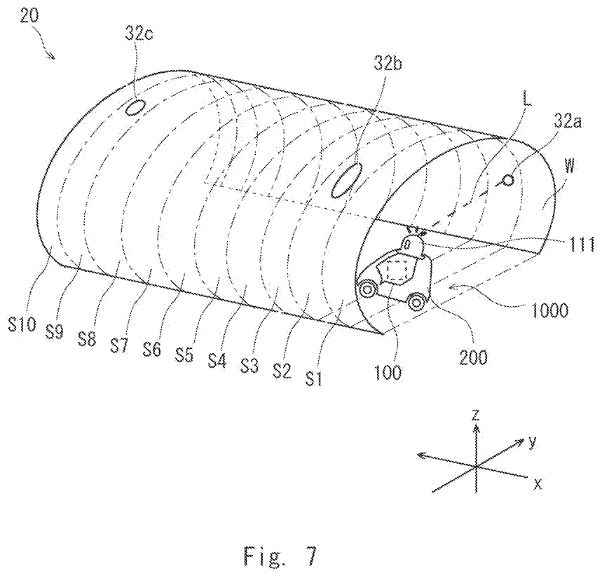

An outline of sensing performed by the sensor 111 will be described with reference to FIG. 7. FIG. 7 is a diagram illustrating an outline of sensing of the sensor 111 and an example of the feature portion to be described later. The sensor 111 senses the side of the vehicle 200. The side of the vehicle 200 includes the radial direction of the tunnel 20 from the vehicle 200 provided with the sensor 111. The side of the vehicle 200 is not limited to the horizontal direction and includes the upper side of the vehicle 200. For example, in a case where the vehicle 200 is located in the section S1, the sensor 111 may sense the inner wall W included in the section S1 in any of upward, downward, rightward, and leftward directions from the vehicle 200. The sensor 111 performs sensing in each of the sections S1, S2, S3, . . . while traveling in the tunnel 20, and outputs a sensing result in each section to the acquisition unit 110.

The sensor 111 is, for example, LiDAR (light detection and ranging, laser imaging detection and ranging) or the like capable of three-dimensionally scanning a space outside the vehicle 200 and acquiring three-dimensional point cloud data of the inner wall W. The present example embodiment is not limited thereto, and the sensor 111 may be a stereo camera, a depth camera, or the like capable of measuring a distance to the inner wall W. In the present example embodiment, description will be made on the assumption that the sensor 111 is a LiDAR.

The sensor 111 is installed at any place of the vehicle 200. The sensor 111 is installed, for example, on the upper surface of the vehicle 200. The sensor 111 irradiates the periphery of the vehicle 200 with laser light L, and detects laser light L reflected by the surrounding object. Here, description will be made on the assumption that the surrounding object is the inner wall W. The sensor 111 measures a time difference from irradiation with laser light L until the laser light L hits on the inner wall W and bounces back. The sensor 111 detects the position of the inner wall W, the distance to the inner wall W, and the shape of the inner wall W based on the measured time difference. The sensor 111 acquires three-dimensional point cloud data including these types of information and outputs the three-dimensional point cloud data to the acquisition unit 110.

The sensor 111 can perform sensing at any timing. In the present example embodiment, description will be made on the assumption that the sensor 111 performs sensing in real time and outputs shape information to the acquisition unit 110. Note that the sensor 111 is mounted on the vehicle 200, and the position thereof is fixed. Therefore, the current position of the sensor 111 at the time of sensing can be regarded as the current position of the vehicle 200.

Returning to FIG. 4, the description will be continued.

The extraction unit 120 corresponds to the extraction unit 12 in the first example embodiment.

The extraction unit 120 extracts the feature portion indicating a shape change on the surface of the inner wall W from the shape information acquired by the acquisition unit 110. Similarly to the reference portion, the feature portion is a portion where the shape change on the surface of the inner wall W is detected.

Similarly to the reference portion, the shape change at the feature portion is, for example, pockmarks (surface bubbles), peeling, flaking, cracking, or the like occurring on the surface of the inner wall W. The shape change is not limited thereto, and may include a recessed portion, a protruding portion, or other changes indicating the deterioration of the surface of the inner wall W. The feature portion may be a location corresponding to the reference portion stored in the reference information DB 130, or may be a location where a new shape change (deterioration) occurs on the surface of the inner wall W after the reference portion is extracted.

The extraction unit 120 extracts the feature portion by using the three-dimensional point cloud data acquired by the acquisition unit 110, based on a change rate of the direction of a normal vector and an error from an approximate curve. Furthermore, the extraction unit 120 extracts feature information including the position and the size of the feature portion.

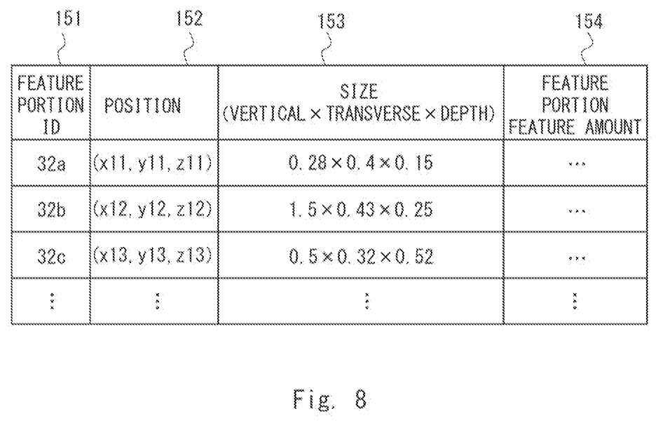

A specific example of the feature information will be described with reference to FIGS. 7 and 8. FIG. 7 illustrates an example of the feature portion. FIG. 8 is a diagram illustrating an example of the feature information corresponding to the feature portion illustrated in FIG. 7.

In FIG. 7, the extraction unit 120 acquires three-dimensional point cloud data in each of the sections S1, S2, S3, . . . from the acquisition unit 110. The extraction unit 120 may acquire the three-dimensional point cloud data of each section from the acquisition unit 110 as needed in accordance with the traveling of the vehicle 200. The extraction unit 120 extracts a feature portion indicating the shape change of the inner wall W in each section from the three-dimensional point cloud data, and outputs the feature portion to the estimation unit 140.

For example, the extraction unit 120 extracts feature portions 32a and 32b based on three-dimensional point cloud data in the section S2. In addition, the extraction unit 120 extracts feature information of each of the feature portions 32a and 32b. In addition, similarly, the extraction unit 120 extracts a feature portion 32c based on three-dimensional point cloud data in the section S9, and extracts feature information at the feature portion 32c.

FIG. 8 is a diagram illustrating an example of feature information corresponding to the feature portions 32a to 32c. The feature information is obtained by associating a feature portion ID 151, a position 152 of each feature portion, a size 153, and a feature portion feature amount 154. The extraction unit 120 may appropriately store these types of information in a storage device (not illustrated).

The feature portion ID 151 is information for identifying the feature portion.

The position 152 is information indicating the position of the feature portion. For example, the position 152 may be calculated based on a direction of the feature portion and a distance to the feature portion with reference to the sensor 111.

The size 153 is information indicating the size of the shape change at the feature portion. The size 153 may include, for example, a vertical length, a transverse length, and a depth of the shape change at the feature portion.

The feature portion feature amount 154 is information indicating a feature amount of the shape change at the feature portion. For example, the feature portion feature amount 154 may indicate a shape, a size, a degree thereof, and the like of pockmarks, peeling, or the like. The feature portion feature amount 154 is calculated based on, for example, the size 153 of the shape change. The reference portion feature amount 134 may be calculated in consideration of the position 152. Similarly to the reference portion feature amount 134, the feature portion feature amount 154 can be acquired by using, for example, artificial intelligence or the like. For example, the extraction unit 120 acquires the feature portion feature amount 154 by learning (for example, deep learning or the like) a large number of images and generating a model for detecting the feature amount of the shape change.

Returning to FIG. 4, the description will be continued.

The estimation unit 140 corresponds to the estimation unit 14 in the first example embodiment.

The estimation unit 140 compares the feature information extracted by the extraction unit 120 with the reference information stored in the reference information DB 130 and estimates the current position of the vehicle 200.

For example, in the example of FIG. 7, the estimation unit 140 acquires the feature information of the feature portion 32a extracted by the extraction unit 120. As illustrated in FIG. 8, the feature information includes, for example, a feature portion ID 151, a position 152, a size 153, and a feature portion feature amount 154 of the feature portion 32a.

The estimation unit 140 collates the reference information stored in the reference information DB 130 with the feature information of the extracted feature portion 32a. For example, the estimation unit 140 refers to the reference information DB 130 and collates the feature portion feature amount 154 included in the feature information of the feature portion 32a with the reference portion feature amount 134 included in the reference information of the reference information DB 130. The estimation unit 140 determines whether or not the reference portion feature amount 134 that coincides with the feature portion feature amount 154 exists in the reference information DB 130.

In a case where the reference portion feature amount 134 that coincides with the feature portion feature amount 154 exists, the estimation unit 140 determines that the feature information coincides with the reference information. Note that, in a case where the feature portion feature amount 154 coincides with the reference portion feature amount 134 by a predetermined threshold value or more, the estimation unit 140 may determine that the feature portion feature amount 154 coincides with the reference portion feature amount 134.

Here, even in a case where the reference portion feature amount 134 does not coincide with the feature portion feature amount 154 by the threshold value or more, the estimation unit 140 may make a determination in consideration of the sizes of the feature portion and the reference portion. For example, even in a case where the size of the feature portion is different from the size of the reference portion, the estimation unit 140 determines that the feature information coincides with the reference information. Specifically, in a case where the size of the feature portion is larger than the size of the reference portion, the estimation unit 140 determines that the feature information coincides with the reference information.

For example, in FIG. 6, the size 133 of the reference portion 31a is “0.2×0.3×0.1”. In addition, in FIG. 8, the size 153 of the feature portion 32a is “0.28×0.4×0.15”. As described above, among the reference portion 31a and the feature portion 32a, the shape change at the feature portion 32a is larger. The estimation unit 140 collates the feature information with the reference information in consideration of such variation in the size of the shape change. In the comparison between the feature information and the reference information, the estimation unit 140 does not set the exact coinciding of the sizes of the shape change as a determination condition for the feature information coinciding with the reference information. For example, in a case where factors other than the size coincide with each other by a predetermined threshold value or more, and the size of the feature portion is larger than the size of the reference portion, the estimation unit 140 determines that the feature information coincides with the reference information.

For example, it is assumed that factors other than the sizes of the feature portion 32a and the reference portion 31a coincide with each other by a predetermined threshold value or more. As described above, the size 153 of the feature portion 32a is larger than the size 133 of the reference portion 31a. Thus, the estimation unit 140 determines that the feature information of the feature portion 32a coincides with the reference information of the reference portion 31a.

In a case where it is determined that the feature information coincides with the reference information, the estimation unit 140 associates the feature portion with the reference portion. Here, the estimation unit 140 associates the feature portion 32a with the reference portion 31a. The position of the reference portion 31a is stored in the reference information DB 130 in advance. The estimation unit 140 estimates the current position of the vehicle 200 based on the distance and the positional relationship between the reference portion 31a and the corresponding feature portion 32a.

As described above, even in a case where the size of the reference portion is different from the size of the feature portion, the estimation unit 140 can estimate the position of the vehicle 200 in association with the reference portion and the feature portion assuming that the reference portion and the feature portion exist at the same position. In this manner, even in a case where the deterioration of the inner wall W progresses and the pockmarks or the like expands, the estimation unit 140 can appropriately estimate the position by correctly associating the reference portion and the feature portion with each other.

Note that, in the examples of FIGS. 6 and 8 described above, the case where all of the vertical length, the transverse length, and the depth are large is used, but the present example embodiment is not limited thereto. The estimation unit 140 may determine that the feature information coincides with the reference information even in a case where only some of the vertical length, the transverse length, and the depth is large. Furthermore, for example, in a case where a plurality of pieces of pockmarks in close proximity form one large pockmark due to deterioration, the estimation unit 140 may associate a plurality of reference portions with one feature portion. Note that, in a case where maintenance is performed on a deteriorated portion, the estimation unit 140 may not refer to this portion. In addition, the method of collating the feature information with the reference information is not limited to the method described above. For example, color information of the inner wall W may be acquired from the sensor 111, and the color information may be added to the determination condition.

Note that, in the above description, the description has been made using only one portion of the feature portion 32a, but the present example embodiment is not limited thereto. The estimation unit 140 may compare a plurality of pieces of feature information with a plurality of pieces of reference information, and estimate the current position based on a plurality of comparison results.

For example, in the example of FIG. 7, the extraction unit 120 extracts the feature portion 32b in addition to the feature portion 32a in the section S2. The estimation unit 140 collates pieces of feature information of the feature portions 32a and 32b with pieces of reference information, and determines whether or not there is reference information that coincides with the feature information. Here, it is assumed that the estimation unit 140 associates the feature portion 32a with the reference portion 31a and associates the feature portion 32b with the reference portion 31b, based on the determination result.

The estimation unit 140 estimates the current position of the vehicle 200 based on the distance and the positional relationship to and with each of the feature portions 32a and 32b. For example, the estimation unit 140 may appropriately correct the current position estimated based on only the feature portion 32a, in accordance with the position estimated based on the feature portion 32b. As described above, by comparing the plurality of pieces of feature information with the pieces of the reference information, the estimation unit 140 can estimate the current position with higher accuracy.

Note that, although the description has been made using the feature portions 32a and 32b in the same section S2, the estimation unit 140 may perform a plurality of comparisons using feature portions in different sections. For example, in the example of FIG. 7, the extraction unit 120 extracts the feature portions 32a and 32b in the section S2, and then extracts the feature portion 32c in the section S9. The estimation unit 140 may estimate the current position by using the estimation result in the section S2 and the estimation result in the section S9.

Note that the estimation unit 140 may appropriately update the reference information DB 130 based on the collation result. For example, the estimation unit 140 updates the reference information of the reference portion 31a with the feature information of the feature portion 32a. In addition, in a case where a new feature portion that does not exist in the reference information DB 130 occurs, the reference information may be added. In this manner, the latest data can be utilized in the position estimation at the time of the next inspection or the like.

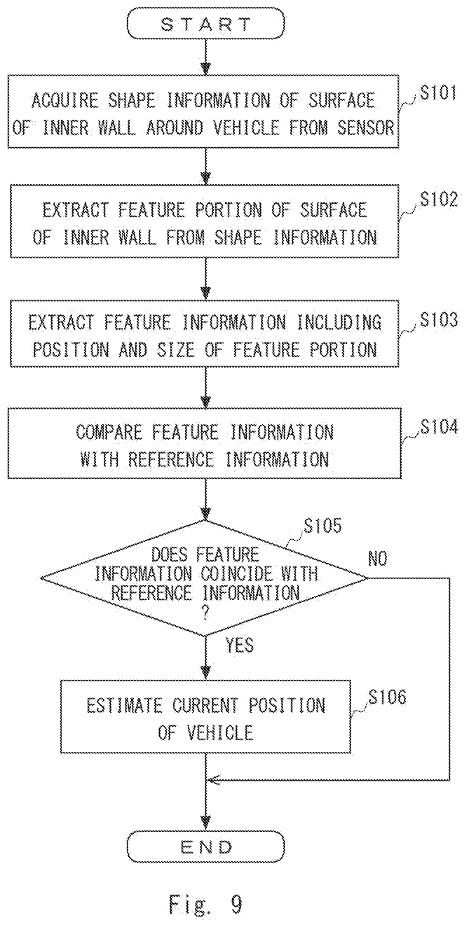

Next, position estimation processing performed by the position estimation device 100 will be described with reference to FIG. 9. FIG. 9 is a flowchart illustrating the position estimation processing. Here, an example in which the vehicle 200 travels in the tunnel 20 in sections S1, S2, S3, . . . as in the example illustrated in FIG. 7 will be assumed and described. The position estimation device 100 detects a feature portion for each section and collates the feature portion with a reference portion to estimate a current position. Note that the description will be made with reference to FIGS. 4 to 8 as appropriate.

It is assumed that the reference information DB 130 (see FIG. 4) stores the reference information in advance. As in the example illustrated in FIG. 6, the reference information is obtained by associating the reference portion ID 131, the position 132, the size 133, the reference portion feature amount 134, and the like with each other.

First, the acquisition unit 110 acquires shape information of the surface of the inner wall W around the vehicle 200 from the sensor 111 (S101). The shape information is, for example, three-dimensional point cloud data of the surface of the inner wall W. The sensor 111 senses the side of the vehicle 200, acquires three-dimensional point cloud data of the surface of the inner wall W, and outputs the three-dimensional point cloud data to the acquisition unit 110.

Then, the extraction unit 120 extracts a feature portion of the surface of the inner wall W from the shape information (S102). The feature portion is a portion where a shape change on the surface of the inner wall W is detected. The shape change is, for example, pockmarks, peeling, flaking, cracking, or the like of the surface of the inner wall W. The shape change is not limited thereto, and may include a shape change indicating deterioration of the inner wall W. The extraction unit 120 extracts a feature portion based on a change rate of the direction of a normal vector and an error from the approximate curve.

Subsequently, the extraction unit 120 extracts feature information including the position and size of the feature portion (S103). As in the example illustrated in FIG. 8, the feature information is obtained by associating a feature portion ID 151, a position 152, a size 153, a feature portion feature amount 154, and the like with each other. The extraction unit 120 acquires three-dimensional point cloud data in each section of the sections S1, S2, S3, . . . from the acquisition unit 110, and extracts feature information of the feature portion in each section.

For example, in the example illustrated in FIG. 7, the extraction unit 120 extracts the feature portions 32a and 32b in the section S2, and extracts the feature information of the feature portions 32a and 32b. In addition, similarly, the extraction unit 120 extracts a feature portion 32c based on three-dimensional point cloud data in the section S9, and extracts feature information at the feature portion 32c.

Then, the estimation unit 140 compares the feature information with the reference information (S104). The estimation unit 140 refers to the reference information DB 130 and collates the feature information extracted in Step S103 with the reference information. For example, the estimation unit 140 collates the extracted feature information of the feature portion 32a with the reference information in the reference information DB 130. The estimation unit 140 determines that the feature information coincides with the reference information not only in a case where the feature information completely coincides with the reference information, but also in a case where the feature information coincides with the reference information by a predetermined threshold value or more.

In addition, even in a case where the size 153 included in the feature information is different from the size 133 included in the reference information, the estimation unit 140 determines that the feature information coincides with the reference information. Here, as illustrated in FIGS. 6 and 8, the size of the shape change in the feature portion 32a is larger than the size of the shape change in the reference portion 31a. However, the estimation unit 140 determines whether or not the feature information of the feature portion 32a coincides with the reference information of the reference portion 31a in consideration of factors other than the size.

The estimation unit 140 determines whether or not the feature information coincides with the reference information (S105). In a case where the feature information does not coincide with the reference information (NO in S105), the processing is ended. In a case where the feature information coincides with the reference information (YES in S105), the estimation unit 140 associates the feature portion with the reference portion. The estimation unit 140 estimates the current position of the vehicle 200 based on the distance and the positional relationship to and with the feature portion (S106).

Here, the description has been made using only one portion of the feature portion 32a, but the present example embodiment is not limited thereto. As described above, the estimation unit 140 may compare a plurality of pieces of feature information with a plurality of pieces of reference information, and estimate the current position based on a plurality of comparison results. The estimation unit 140 may compare the feature information with the reference information for the feature portions 32a and 32b extracted in the section S2. Furthermore, the estimation unit 140 may perform comparison by further using the feature information of the feature portion 32c extracted in the section S9 and the reference information.

As described above, the position estimation device 100 according to the present example embodiment acquires the shape information of the surface of the inner wall W, and extracts the shape change of the surface of the inner wall W from the shape information. The shape change includes deterioration of the surface of the inner wall W. The position estimation device 100 extracts feature information including the position and the size for the deterioration, and compares the feature information with reference information stored in advance. Even in a case where the size of the feature portion is larger than the size of the corresponding reference portion, the position estimation device 100 associates the feature portion with the reference portion on the assumption that the feature portion and the reference portion exist at the same position. The position estimation device 100 estimates the current position of the vehicle 200 based on the position of the reference portion associated with the feature portion.

As described above, the position estimation device 100 does not need strict coinciding of the size between the reference portion and the feature portion in the comparison between the reference portion and the feature portion. As a result, even in a case where the feature portion is larger than the reference portion measured in the past, it is possible to appropriately grasp the current position of the vehicle 200 based on the position of the reference portion associated with the feature portion.

### Third Example Embodiment

Next, a moving object system 1001 according to a third example embodiment will be described.

The second example embodiment has been described using an example in which the position estimation device 100 includes one sensor 111. In the present example embodiment, a position estimation device 100 includes a plurality of sensors.

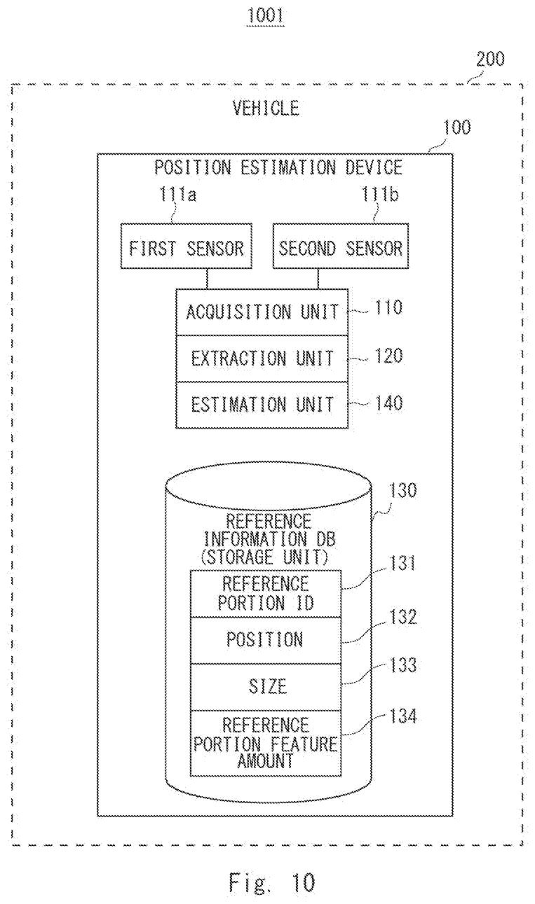

FIG. 10 is a block diagram illustrating a configuration of the moving object system 1001 according to the present example embodiment. Similarly to the moving object system 1000 described in the second example embodiment, the moving object system 1001 includes a vehicle 200 and the position estimation device 100 mounted on the vehicle 200. The configuration of the position estimation device 100 is similar to that of the moving object system 1000 except that the position estimation device 100 includes a first sensor 111a and a second sensor 111b.

The first sensor 111a and the second sensor 111b sense the peripheral of the vehicle 200 and output sensing results to the acquisition unit 110. The first sensor 111a and the second sensor 111b detect a shape of an object existing in a space outside the vehicle 200 and acquire shape information of the object.

The first sensor 111a corresponds to the sensor 111 in the second example embodiment. The first sensor 111a senses the side of the vehicle 200 by the sensor 111.

The second sensor 111b is a sensor that performs sensing in a direction different from that of the first sensor 111a. The second sensor 111b senses the front of the vehicle 200, for example. The front of the vehicle 200 refers to a traveling direction of the vehicle 200 (x-axis positive direction).

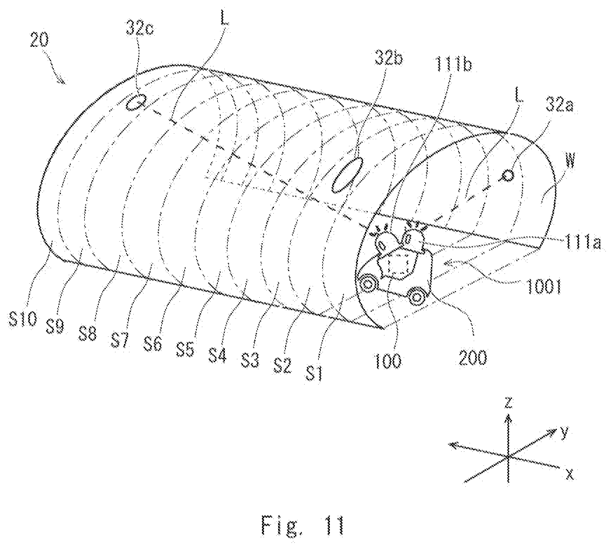

FIG. 11 is a diagram illustrating an outline of sensing performed by the first sensor 111a and the second sensor 111b. Similarly to the second example embodiment, the first sensor 111a and the second sensor 111b may be LiDAR, a stereo camera, a depth camera, or the like. Here, it is assumed that the first sensor 111a and the second sensor 111b are LiDAR. The first sensor 111a and the second sensor 111b are installed on an upper surface of the vehicle 200 or the like. The first sensor 111a and the second sensor 111b irradiate the periphery of the vehicle 200 with laser light L, and detect laser light L reflected by the surface of the inner wall W.

In FIG. 11, the vehicle 200 is located within the section S2. The front of the vehicle 200 indicates sections S3, S4, S5, . . . on the traveling direction side of the section S2. For example, the first sensor 111a scans the inner wall W in the section S2, and the second sensor 111b scans the inner wall W in the sections S3, S4, S5, . . . in front of the section S2. The first sensor 111a and the second sensor 111b output the respective sensing results to the acquisition unit 110.

Returning to FIG. 10, the description will be continued.

The extraction unit 120 extracts the feature portion indicating a shape change on the surface of the inner wall W from the shape information acquired by the acquisition unit 110, in the similar manner to that in the second example embodiment. For example, the extraction unit 120 extracts feature portions 32a and 32c illustrated in FIG. 11 from the shape information acquired by each of the first sensor 111a and the second sensor 111b. In addition, the extraction unit 120 extracts feature information of each of the feature portions 32a and 32c.

The estimation unit 140 compares feature information of the feature portions 32a and 32c with reference information stored in the reference information DB 130. In a case where the feature portions 32a and 32c coincide with the reference information, the current position of the vehicle 200 is estimated by associating the corresponding reference portions with the respective feature portions. Similarly to the second example embodiment, even in a case where the size of each feature portion is different from the size of the reference information, the estimation unit 140 can associate the feature portion and the reference portion on the assumption that the feature portion and the reference portion are at the same position. Details of the processing including the flowchart are similar to those in the second example embodiment. Therefore, the repetitive description thereof will be omitted.

As described above, according to the moving object system 1001 according to the present example embodiment, it is possible to estimate the position in consideration of not only the feature information of the side of the vehicle 200 but also the feature information of the front of the vehicle 200. Thus, it is possible to obtain the similar effects to those in the second example embodiment.

### Fourth Example Embodiment

Next, a moving object system 1002 according to a fourth example embodiment will be described.

In the second and third example embodiments, the extraction unit 120 extracts a feature portion such as pockmarks occurring on the surface of the inner wall W based on a change rate in the direction of a normal vector on the inner wall W, and the like. In the present example embodiment, the extraction unit 120 extracts the feature portion on the inner wall W based on a reflected light intensity of a beam with which the inner wall W is irradiated.

In the present example embodiment, the feature portion indicates a region having a reflectance significantly different from that of the periphery of the feature portion in the inner wall W. The feature portion is, for example, paint provided on the inner wall W. The paint may be provided on the inner wall W for position estimation, or may be provided in advance on the inner wall W for other purposes. The paint is, for example, a paint applied to the inner wall W. Note that, instead of the paint, a tile, a tape, or the like may be used as the feature portion.

The moving object system 1002 according to the present example embodiment will be described.

A configuration of the moving object system 1002 is similar to the configuration of the moving object system 1000 described with reference to FIG. 4. Therefore, description will be made with reference to FIG. 4.

As illustrated in FIG. 4, the moving object system 1002 includes a vehicle 200 and a position estimation device 100 mounted on the vehicle 200. The position estimation device 100 further includes a sensor 111, an acquisition unit 110, an extraction unit 120, a reference information DB 130, and an estimation unit 140.

The sensor 111 irradiates the surface of the inner wall W with laser light L (beam) and receives reflected light from the inner wall W. The sensor 111 outputs the intensity of the reflected light to the acquisition unit 110.

The acquisition unit 110 acquires, from the sensor 111, the reflected light intensity of the laser light L with which the surface of the inner wall W is irradiated.

The extraction unit 120 extracts a feature portion based on the reflected light intensity acquired by the acquisition unit 110. Furthermore, the extraction unit 120 extracts feature information including the position of the feature portion.

The reference information DB 130 functions as a storage unit that stores reference information of a reference portion that is a reference for position estimation. A specific example of the reference information DB 130 will be described later.

The estimation unit 140 compares the feature information extracted by the extraction unit 120 with the reference information stored in the reference information DB 130 and estimates the current position of the vehicle 200.

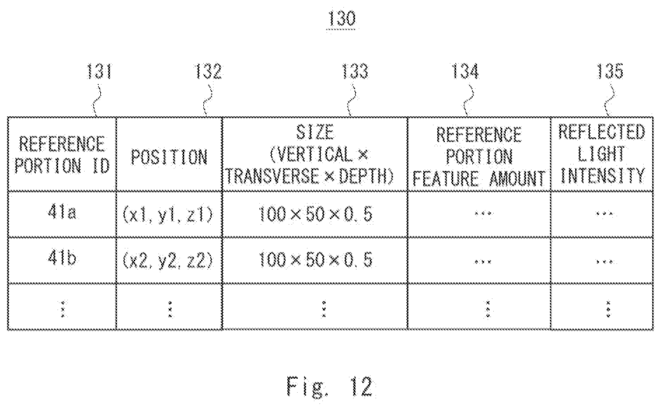

FIG. 12 is a diagram illustrating an example of the reference information DB 130. The reference information DB 130 stores a reflected light intensity 135 in association with the reference portion ID 131, the position 132, the size 133, and the reference portion feature amount 134 described in the second example embodiment. Note that the content of the reference information DB 130 is not limited to the content illustrated in FIG. 12.

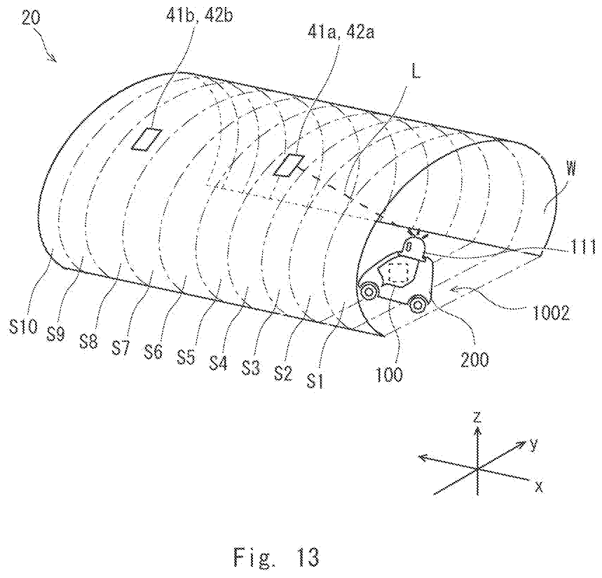

An outline of sensing performed by the sensor 111 according to the present example embodiment will be described with reference to FIG. 13. FIG. 13 is a diagram illustrating an outline of sensing of the sensor 111. In addition, FIG. 13 illustrates an example of the reference portion and the feature portion according to the present example embodiment. Note that, similarly to the second example embodiment, the sensor 111 may sense the side of the vehicle 200, but here, an example of sensing the front of the vehicle 200 will be described.

In FIG. 13, a paint is applied in sections S4 and S8. The painted portions are reference portions 41a and 41b. Reference information of the reference portions 41a and 41b is stored in the reference information DB 130 in advance as in the example of FIG. 12.

First, the sensor 111 irradiates the surface of the inner wall W with laser light L. Here, as illustrated in FIG. 13, it is assumed that the position of a feature portion 42a is irradiated with laser light L. The sensor 111 receives reflected light from the inner wall W, detects a reflected light intensity, and outputs the reflected light intensity to the acquisition unit 110. The acquisition unit 110 acquires the reflected light intensity of the laser light L from the sensor 111.

The extraction unit 120 extracts a feature portion based on the reflected light intensity. The extraction unit 120 extracts the feature portion 42a based on a difference in reflected light intensity from other areas. In addition, the extraction unit 120 extracts feature information including the position of the feature portion 42a. The feature information may include the reflected light intensity at the feature portion 42a in addition to the elements described with reference to FIG. 8. For example, the extraction unit 120 associates the feature portion ID 151, the position 152 of the feature portion, the size 153, the feature portion feature amount 154, and the reflected light intensity with each other to obtain feature information. Note that the content of the feature information is not limited thereto. In addition, the extraction unit 120 may appropriately store these types of information in a storage device (not illustrated).

The estimation unit 140 compares the feature information extracted by the extraction unit 120 with the reference information stored in the reference information DB 130 and estimates the current position of the vehicle 200. For example, the estimation unit 140 compares the feature information of the feature portion 42a with the reference information. The estimation unit 140 determines whether or not the feature portion 42a coincides with the reference portion 41a. In a case where the feature portion 42a coincides with the reference portion 41a by a threshold value or more, the estimation unit 140 determines that the feature portion 42a coincides with the reference portion 41a. The comparison between the feature information and the reference information is similar to that in the second example embodiment, and thus the detailed description thereof will be omitted.

Note that, on the contrary to the second example embodiment, the estimation unit 140 may determine that the reference information coincides with the feature information even in a case where the size of the feature portion is small. In this manner, the estimation unit 140 can specify the position of the feature portion, for example, even in a case where the paint is peeled off. Furthermore, the estimation unit 140 may perform determination in consideration of a change in reflected light intensity caused by deterioration of the paint or the like.

The estimation unit 140 estimates the current position of the vehicle 200 based on the distance and the positional relationship to and with the feature portion 42a by associating the feature portion 42a with the reference portion 41a. Note that, similarly to the second example embodiment, the estimation unit 140 may estimate the current position of the vehicle 200 by using the plurality of feature portions 42a and 42b.

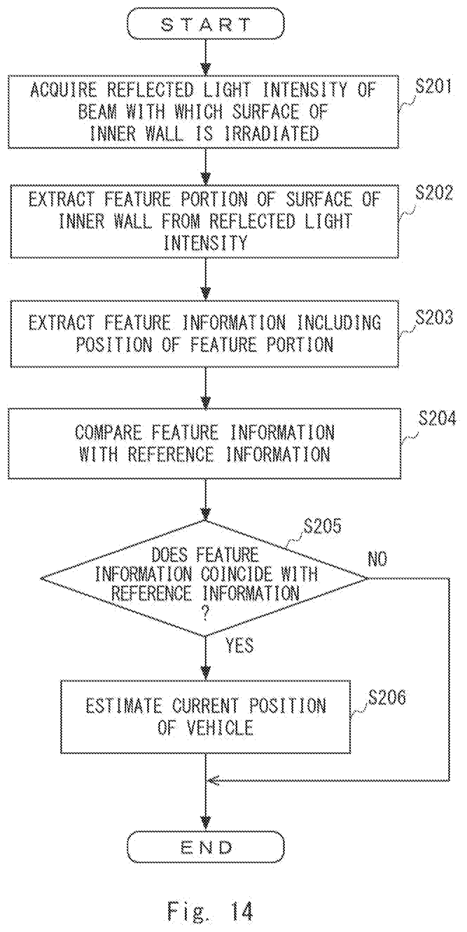

FIG. 14 is a flowchart illustrating position estimation processing according to the present example embodiment. Description of parts similar to those in the second example embodiment will be omitted as appropriate.

The sensor 111 irradiates the surface of the inner wall W with a beam. The acquisition unit 110 acquires a reflected light intensity of the beam with which the surface of the inner wall W is irradiated (S201). The extraction unit 120 extracts a feature portion of the surface of the inner wall W from the reflected light intensity (S202). The feature portion is, for example, a paint applied to the inner wall W. Not only the paint but also a tile or the like having a reflectance significantly different from other areas may be used. The extraction unit 120 extracts feature information including the position of the feature portion (S203).

The estimation unit 140 compares the feature information with reference information (S204). The estimation unit 140 refers to the reference information DB 130 and collates the reference information with the feature information extracted in Step S203. For example, in the example of FIG. 13, the estimation unit 140 collates the extracted feature information of the feature portion 42a with the reference information in the reference information DB 130. The estimation unit 140 determines that the reference information coincides with the feature information not only in a case where the reference information completely coincides with the feature information, but also in a case where the reference information coincides with the feature information by a predetermined threshold value or more.

The estimation unit 140 determines whether the reference information coincides with the feature information (S205). In a case where the reference information does not coincide with the feature information (NO in S205), the processing is ended. In a case where the reference information coincides with the feature information (YES in S205), the estimation unit 140 associates the feature portion with the reference portion. For example, the estimation unit 140 associates the feature portion 42a with the reference portion 41a. The estimation unit 140 estimates the current position of the vehicle 200 based on the distance and the positional relationship to and with the feature portion 42a (S206).

As described above, according to the moving object system 1002 according to the present example embodiment, it is possible to obtain the similar effects to those in the second example embodiment. In addition, since the position estimation is performed by using the paint or the like applied to the inner wall W, it is possible to easily estimate the position, for example, even in a case where there is no past inspection result or the like. In addition, since estimation is performed in combination with the shape change of the surface of the inner wall W, it is possible to estimate the current position of the vehicle 200 with higher accuracy.

Some or all of the first to fourth example embodiments described above can be appropriately combined and used. In addition, each device is not limited to a physically single device, and may be configured by a plurality of devices. In addition, the functions of the respective devices can be realized by a plurality of processing devices performing distributed processing.

### Configuration Example of Hardware

Each functional component unit of the position estimation device 100 may be realized by hardware that realizes each functional configuration unit (for example, a hard-wired electronic circuit) or may be realized by a combination of hardware and software (for example, a combination of an electronic circuit and a program that controls the electronic circuit or the like). A case where each functional component unit of the position estimation device 100 is realized by a combination of hardware and software will be further described.

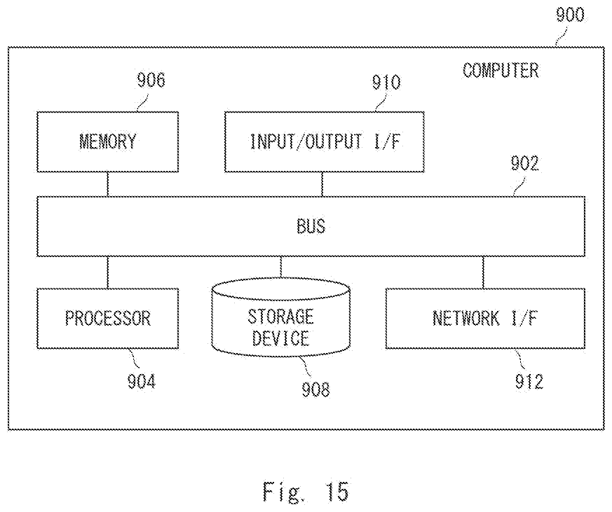

FIG. 15 is a block diagram illustrating a configuration example of hardware of a computer 900 that realizes the position estimation device 100. The computer 900 may be a dedicated computer designed to realize the position estimation device 100 or may be a general-purpose computer. The computer 900 may be a portable computer such as a smartphone and a tablet terminal.

For example, by installing a predetermined application on the computer 900, each function of the position estimation device 100 is realized by the computer 900. The above-described application is configured by a program for realizing the functional component units of the position estimation device 100.

The computer 900 includes a bus 902, a processor 904, a memory 906, a storage device 908, an input/output interface 910, and a network interface 912. The bus 902 is a data transmission path for the processor 904, the memory 906, the storage device 908, the input/output interface 910, and the network interface 912 to transmit and receive data to and from each other. However, a method of connecting the processor 904 and the like to each other is not limited to the bus connection.

The processor 904 is a variety of processors such as a central processing unit (CPU), a graphics processing unit (GPU), and a field-programmable gate array (FPGA). The memory 906 is a main storage device realized by using a random access memory (RAM) or the like. The storage device 908 is an auxiliary storage device realized by using a hard disk, a solid state drive (SSD), a memory card, a read only memory (ROM), or the like. At least one of the memory 906 or the storage device 908 may be used as the reference information DB 130 (see FIGS. 4 and 10).

The input/output interface 910 is an interface for connecting the computer 900 and an input/output device. For example, an input device such as a keyboard and an output device such as a display device are connected to the input/output interface 910.

The network interface 912 is an interface for connecting the computer 900 to a network. The network may be a local area network (LAN) or may be a wide area network (WAN).

The storage device 908 stores a program (program for realizing the above-described application) for realizing each functional component unit of the position estimation device 100. The processor 904 reads the program to the memory 906 and executes the program to realize each functional component unit of the position estimation device 100.

Each of the processors executes one or more programs including a command group for causing a computer to perform the algorithm described with reference to the drawings. The program includes a command group (or software codes) for causing the computer to perform one or more functions that have been described in the example embodiments in a case where the program is read by the computer. The program may be stored in a non-transitory computer readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communication medium. By way of example, and not limitation, transitory computer-readable or communication media include electrical, optical, acoustic, or other forms of propagated signals.

Note that the present disclosure is not limited to the above example embodiments, and can be appropriately changed without departing from the gist.

Some or all of the above-described example embodiments can be described as in the following Supplementary Notes, but are not limited to the following Supplementary Notes.

### Supplementary Note 1

A position estimation device configured to estimate a current position of a moving object, the position estimation device including:
acquisition means for acquiring shape information of a surface of a structure around a moving object;
extraction means for extracting a feature portion indicating a shape change of the surface of the structure from the shape information and extracting feature information including a position and a size of the feature portion;
storage means for storing, in advance, reference information including a position and a size of a reference portion that is a reference for position estimation; and
estimation means for comparing the feature information with the reference information and estimating the current position of the moving object.

### Supplementary Note 2

The position estimation device according to Supplementary Note 1, in which the shape change includes deterioration of the surface of the structure.

### Supplementary Note 3

The position estimation device according to Supplementary Note 1 or 2, in which the size of the feature portion is different from the size of the reference portion.

### Supplementary Note 4

The position estimation device according to any one of Supplementary Notes 1 to 3, in which the moving object moves inside the structure having a hollow shape.

### Supplementary Note 5

The position estimation device according to any one of Supplementary Notes 1 to 4, in which
the acquisition means acquires a reflected light intensity of a beam with which the surface of the structure is irradiated, and
the extraction means extracts the feature portion based on the reflected light intensity.

### Supplementary Note 6

The position estimation device according to any one of Supplementary Notes 1 to 5, in which the estimation means compares a plurality of pieces of the feature information with a plurality of pieces of the reference information, and estimates the current position based on a plurality of comparison results.

### Supplementary Note 7

The position estimation device according to any one of Supplementary Notes 1 to 6, in which the acquisition means includes a first sensor configured to sense a side of the moving object, and a second sensor configured to sense a front of the moving object.

### Supplementary Note 8

A moving object system including:
a moving object; and
a position estimation device mounted on the moving object, in which
the position estimation device includes
acquisition means for acquiring shape information of a surface of a structure around the moving object,
extraction means for extracting a feature portion indicating a shape change of the surface of the structure from the shape information and extracting feature information including a position and a size of the feature portion,
storage means for storing, in advance, reference information including a position and a size of a reference portion that is a reference for position estimation, and
estimation means for comparing the feature information with the reference information and estimating the current position of the moving object.

### Supplementary Note 9

The moving object system according to Supplementary Note 8, in which the shape change includes deterioration of the surface of the structure.

### Supplementary Note 10

A position estimation method of estimating a current position of a moving object, the position estimation method including:
acquiring shape information of a surface of a structure around a moving object;
extracting a feature portion indicating a shape change of the surface of the structure from the shape information and extracting feature information including a position and a size of the feature portion; and
comparing the feature information with reference information including a position and a size of a reference portion that is a reference for position estimation, and estimating the current position of the moving object.

### Supplementary Note 11

A non-transitory computer readable medium storing a program for causing a computer to execute a position estimation method of estimating a current position of a moving object, the program for causing the computer to execute:
an acquisition process of acquiring shape information of a surface of a structure around the moving object;
an extraction process of extracting a feature portion indicating a shape change of the surface of the structure from the shape information and extracting feature information including a position and a size of the feature portion; and
an estimation process of comparing the feature information with reference information including a position and a size of a reference portion that is a reference for position estimation, and estimating the current position of the moving object.

### REFERENCE SIGNS LIST

10 POSITION ESTIMATION DEVICE
11 ACQUISITION UNIT
12 EXTRACTION UNIT
13 STORAGE UNIT
14 ESTIMATION UNIT
20 TUNNEL
31a, 31b, 31c, 41a, 41b REFERENCE PORTION
32a, 32b, 32c, 42a, 42b FEATURE PORTION
100 POSITION ESTIMATION DEVICE
110 ACQUISITION UNIT
111 SENSOR
111a FIRST SENSOR
111b SECOND SENSOR
120 EXTRACTION UNIT
130 REFERENCE INFORMATION DB
131 REFERENCE PORTION ID
132 POSITION
133 SIZE
134 REFERENCE PORTION FEATURE AMOUNT
135 REFLECTED LIGHT INTENSITY
140 ESTIMATION UNIT
151 FEATURE PORTION ID
152 POSITION
153 SIZE
154 FEATURE PORTION FEATURE AMOUNT
200 VEHICLE
900 COMPUTER
902 BUS
904 PROCESSOR
906 MEMORY
908 STORAGE DEVICE
910 INPUT/OUTPUT INTERFACE
912 NETWORK INTERFACE
1000, 1001, 1002 MOVING OBJECT SYSTEM
L LASER LIGHT
S1 to S10 SECTION
W INNER WALL

What is claimed is:

1. A position estimation device configured to estimate a current position of a moving object, the position estimation device comprising:
at least one memory storing instructions; and
at least one processor configured to execute the instructions to:
acquire shape information of a surface of a structure around a moving object;
extract a feature portion indicating a shape change of the surface of the structure from the shape information and extract feature information including a position and a size of the feature portion;
store, in advance, reference information including a position and a size of a reference portion that is a reference for position estimation; and
compare the feature information with the reference information and estimate the current position of the moving object.

2. The position estimation device according to claim 1, wherein the shape change includes deterioration of the surface of the structure.

3. The position estimation device according to claim 1, wherein the size of the feature portion is different from the size of the reference portion.

4. The position estimation device according to claim 1, wherein the moving object moves inside the structure having a hollow shape.

5. The position estimation device according to claim 1, wherein the at least one processor is further configured to execute the instructions to:
acquire a reflected light intensity of a beam with which the surface of the structure is irradiated; and
extract the feature portion based on the reflected light intensity.

6. The position estimation device according to claim 1, wherein the at least one processor is further configured to execute the instructions to compare a plurality of pieces of the feature information with a plurality of pieces of the reference information, and estimate the current position based on a plurality of comparison results.

7. The position estimation device according to claim 1, wherein the at least one processor is further configured to execute the instructions to sense a side of the moving object by a first sensor, and sense a front of the moving object by a second sensor.

8. (canceled)

9. (canceled)

10. A position estimation method of estimating a current position of a moving object, the position estimation method comprising:
acquiring shape information of a surface of a structure around a moving object;
extracting a feature portion indicating a shape change of the surface of the structure from the shape information and extracting feature information including a position and a size of the feature portion; and
comparing the feature information with reference information including a position and a size of a reference portion that is a reference for position estimation, and estimating the current position of the moving object.

11. A non-transitory computer readable medium storing a program for causing a computer to execute a position estimation method of estimating a current position of a moving object, the program for causing the computer to execute:
an acquisition process of acquiring shape information of a surface of a structure around the moving object;
an extraction process of extracting a feature portion indicating a shape change of the surface of the structure from the shape information and extracting feature information including a position and a size of the feature portion; and
an estimation process of comparing the feature information with reference information including a position and a size of a reference portion that is a reference for position estimation, and estimating the current position of the moving object.
